(19) United States
(12) Patent Application Publication
(10) Pub. No.: US 2011/0215122 A1
(43) Pub. Date: Sep. 8, 2011

(54) Headset Caddy

(76) Inventor: Richard Osborne, Doylestown, PA (US)

(21) Appl. No.: 13/042,030

(22) Filed: Mar. 7, 2011

Related U.S. Application Data
(60) Provisional application No. 61/311,430, filed on Mar. 8, 2010.

(51) Int. Cl. B60R 7/04; B65D 85/00

(52) U.S. Cl. 224/275

(57) ABSTRACT

A headphone holder and storage case includes a simple hinged lid with attachments means on the outside surface which can conveniently attach to the back of the front seat headrest. As such, the case faces the backset, and as it is opened presents itself directly to the rear seat occupants. According to one embodiment of the invention, the hinge includes 90° stops so that the bottom section of the case which includes the storage compartments is held in a convenient near horizontal orientation 90° from the vertically oriented lid without any side access restriction. The storage space portion of the case includes a horseshoe-shaped storage compartment which is configured to dimensionally receive the headphones. A central section has individual cavities which function as separate containment pockets for extra fresh batteries so that they are available as spares if needed.

### RELATED APPLICATION

This patent application is related to provisional patent application Ser. No. 61/311,430 entitled “Headset Holder” filed on Mar. 8, 2010, priority from which is hereby claimed.

### FIELD OF THE INVENTION

The present invention relates to a storage case for audio headphones. More specifically, it relates to a headphone storage case adapted for use in a motor vehicle.

### BACKGROUND OF THE INVENTION

Vehicles sold currently often include many entertainment devices for use by children to occupy them while traveling in the car. These devices are primarily used in the area of the backseat where children most often ride. One of the most commonly used entertainment devices are those audio/visual systems which include personal headphone sets so that the sound from those entertainment systems does not annoy or distract the driver. A problem exists however with the use of headphones by children in that the headphones and their associated wiring are often damaged when they are not in use because they lack a proper storage location. Many vehicles include general storage compartments but none is conveniently designed for headset storage. Also, there is often the need for storage for extra batteries since these entertainment devices are often battery powered.

U.S. Pat. No. 7,188,896 issued to Embach entitled “Headphone Structure and Storage Therefore” discloses a headphone headset compartment built into the seat headrest of a motor vehicle so that occupants of the rear seat can access the back of the front seat headrest for storage and removal of headphones. The storage compartment includes a hinged lid with the hinge located at the top. The storage compartment is an integral part of the headrest and not removable from the vehicle. The storage compartment includes no specially designed facility for storing any headphone accessories.

U.S. Pat. No. 7,643,645 issued to Richards entitled “Vehicular Packaging System for Headphone Devices” discloses a headset holder integrally formed of the headrest which includes a stowage portion in an elongate arcuate recess formed in its outer surface to receive the earphones. The retainer clip is mounted to the headset holder for receiving the headset band.

U.S. Pat. No. 5,046,433 issued Kramer et al.; U.S. Patent Application Publication 2006/0149430 and U.S. Design Patent 419,520 all disclose storage devices mounted to vehicle seatbacks with various strapping means for securing the device to the seatback. These are included to hold an opened portion of the storage devices in a substantially horizontal orientation. None of these three references disclose a holder specifically designed for earphone headsets or their accessories. The prior art seatback storage solutions which have a portion held in a substantially horizontal position when opened, all require tensioned side supports which restrict side access.

Therefore, despite these efforts in the art for vehicle headset storage, there still exists a need for an easily attached and removable headset storage case which provides unrestricted access to headset and accessory storage including the need for a battery storage compartment since headset entertainment devices are often battery powered.

### SUMMARY OF THE INVENTION

In order to meet the needs in the art explained above, the present headphone holder and storage case has been devised. The case includes a simple hinged lid with attachment means on the outside surface which can conveniently attach to the back of the front seat headrest. As such, the case faces the backseat, and as it is opened presents itself directly to the rear seat occupants. According to one embodiment of the invention, the hinge includes 90° stops so that the bottom section of the case which includes the storage compartments is held in a convenient near horizontal orientation 90° from the vertically oriented lid without any side access restriction. Hence, it functions as a convenient headphone holder while it remains open as well as a permanent storage case when it is closed. The storage space portion of the case includes a horseshoe-shaped storage compartment which is configured to dimensionally receive the headphones. The case further includes a central section which is surrounded on three sides by the headset storage cavity. The central section has individual cavities which function as separate containment pockets for extra fresh batteries so that they are available as spares if needed.

More specifically, the Applicant has devised a headset case having an outer body defining an enclosed storage space therein. A hinged lid forms a portion of the case outer body and provides user access to the storage space when open. The lid is hingedly attached along a bottom edge of the lid to a storage portion of the case outer body which defines the storage space, the storage space portion being rotatable between fully open and closed positions about the hinge. A restraint against the force of gravity stops the opening of the lid after approximately 90° of case opening. The case can include a band for removably mounting the lid of the case in a substantially vertical orientation to the seatback of a motor vehicle. The storage space includes a horseshoe-shaped recessed compartment for holding the headset. When opened, the storage space presents itself to users who occupy the rear seats of the vehicle. Gravity restraint means holds the storage portion of the case at a fully opened position while in a substantially horizontal orientation. The gravity restraint means comprises rigid hinge stops extending from the bottom of the case body that compressively abut the bottom surface of the lid when the case is fully opened and provides unrestricted side access. Means for removably mounting said case to said seatback comprise a band encircling headrest stanchions on the top of said vehicle seat. An optional clip affixed to a rear surface of the lid is used to engage the mounting band. The storage space also includes a central location located between the legs of the horseshoe cavity for holding batteries. Individual containment pockets hold each of the batteries. The pocket is closely dimensioned to receive each battery individually.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a left front isometric view of two examples of the invention, one shown closed and the other shown in its opened condition.

FIG. 2 is a bottom right rear isometric view of the headset case of the invention.

FIG. 3 is a top right front isometric view of the headset case of the invention shown in its opened condition.

### DESCRIPTION OF THE PREFERRED EMBODIMENT

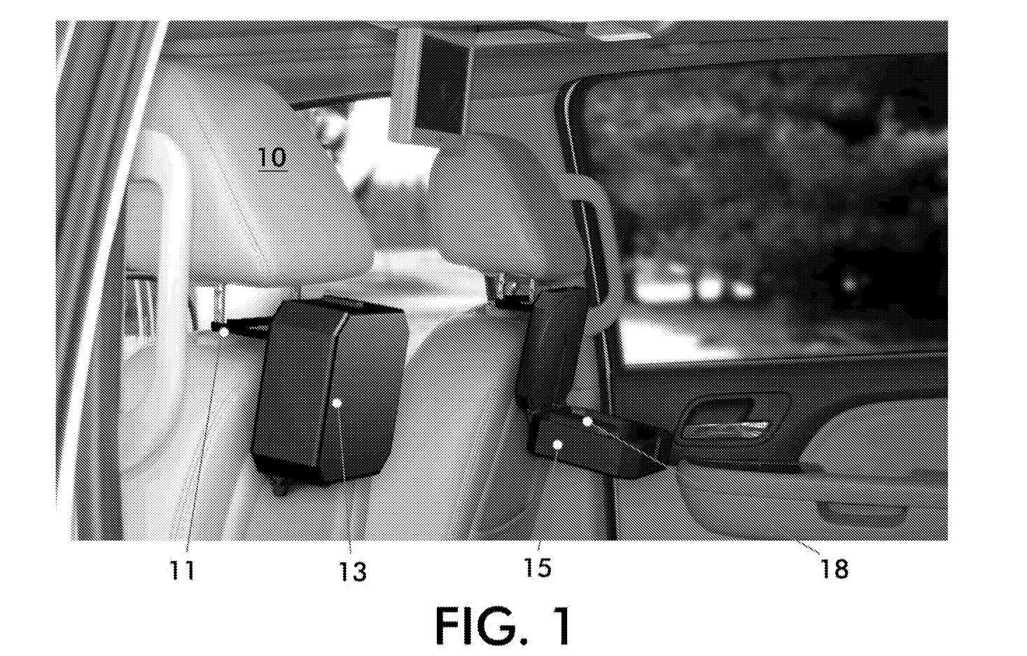

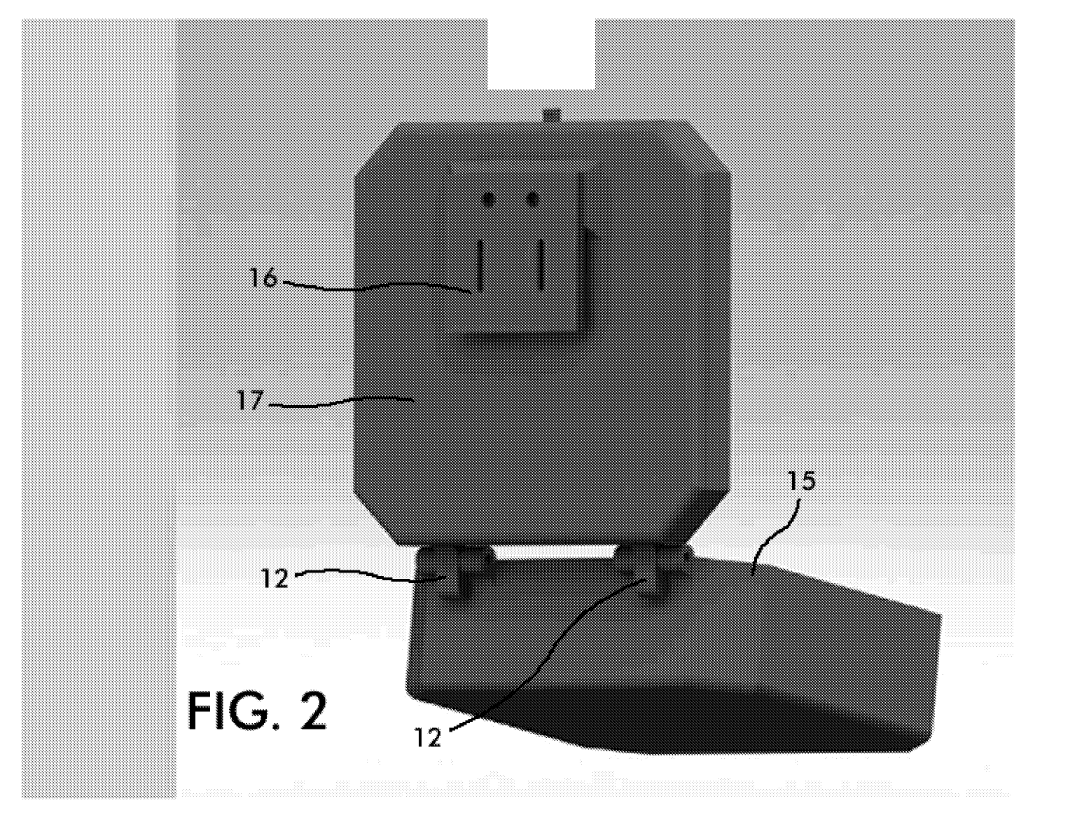

Referring now to FIG. 1, the rear seat area of a typical vehicle in which the invention may be used is depicted. The near side driver's seat includes the headset case 13 of the invention secured around the headrest stanchions by a band 11 with the case shown in its closed position. The rear of the far side passenger side seat includes a duplicate example of the invention also similarly secured to the back of the seat by a band but with the case open. The opened case demonstrates the effect of 90° stops shown in FIG. 2 which hold the storage portion 15 of the case that includes the storage compartments in a convenient near horizontal orientation so that the headsets may be temporarily held by the case for easy removal and replacement without needing to open and close the case each time access is required. It can be observed from FIG. 2 that the stops hold the storage portion of the case in an opened conditioned with unrestricted lateral side access. Convenient spare battery compartments are provided in a central section 18 of the base. It will be readily appreciated that when the case is detached from the seats, the cases can be stored in the cargo area or trunk of a vehicle or elsewhere to protect the headsets against damage.

Referring now to FIG. 2, the case lid includes an optional clip 16 that can receive an attachment band such as band 11 for securing the case to the back of the vehicle seats as shown in FIG. 1. Extensions 12 at the base of the lid 17 provide 90° opening stops against the back of the case that maintain the storage portion of the case 15 in that orientation when opened due to the pull of gravity on the storage portion. It may be understood that in place of the use of the clip, the band 11 may be secured directly to the lid and may include a buckle or be elastic in nature to provide any easy connection to the seat.

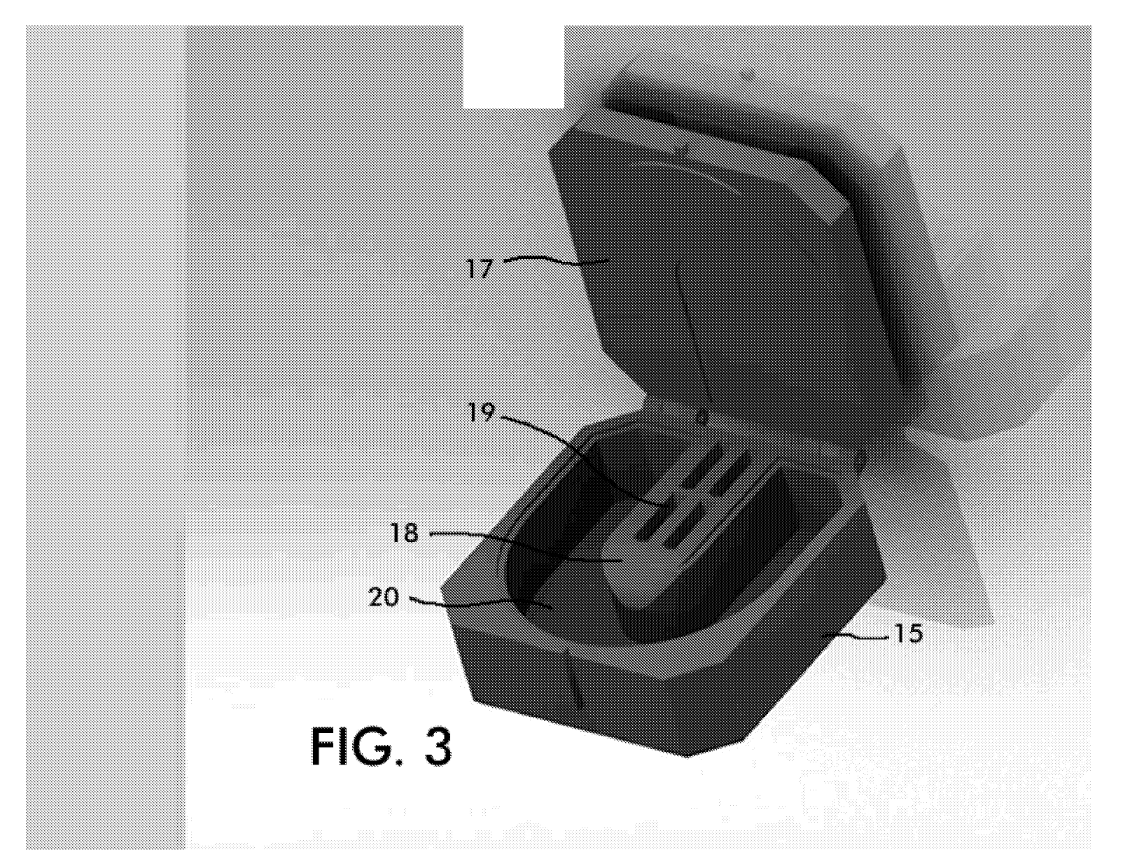

Referring now to FIG. 3, the case includes a horseshoe-shaped cavity 20 which provides a storage compartment for the headset. A raised central section 18 includes containment pockets 19 to individually receive spare batteries (not shown). Although four battery pockets are shown in this Figure, it will be readily appreciated that the number of pockets may be varied by the manufacturer as desired and the individual batteries may be held in any convenient orientation either standing up or laying down.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention as claimed.

What is claimed as being new and desired to be protected by letters patent of the United States is as follows:

What is claimed is:

1. A headset case comprising:
a case outer body defining an enclosed storage space therein;
a hinged lid forming a portion of said case outer body and providing user access to said storage space, said lid attached by a hinge along its bottom edge to a storage portion of said outer body defining said storage space, said storage portion rotatable between closed and fully opened positions about the hinge affixed to said lid;
gravity restraint means restricting the opening of said case after approximately 90° of case opening; and
means for removably mounting said headset case lid to the seatback of a motor vehicle seat in a substantially vertical orientation.

2. The case of claim 1 further including a horseshoe-shaped recessed compartment within said storage space for holding said headset.

3. The case of claim 2 wherein said case is further described as facing rearward of said vehicle seat such that storage space presents itself to users who occupy rear seats of said vehicle which face the back of said seat.

4. The case of claim 3 wherein said gravity restraint means holds said storage portion in a substantially horizontal orientation when said case is in the fully opened position.

5. The case of claim 4 wherein said gravity restraint means comprise hinge stops extending rigidly from the bottom of said case body that compressively abut a bottom surface of said lid and provide unrestricted side access when said case is fully opened.

6. The case of claim 5 wherein said means for removably mounting said case comprises a band encircling headrest stanchions on the top of said vehicle seat.

7. The case of claim 6 wherein said mounting means comprise a clip affixed to a rear surface of said lid which engages said band.

8. The case of claim 7 wherein said storage space includes a raised central section located between the legs of said horseshoe cavity for holding batteries.

9. The case of claim 8 wherein said central section of said storage space includes individual containment pockets for holding each of said batteries, said pockets each dimensioned to closely receive each battery.

10. The case of claim 9 wherein said headsets are audio headphones.
